(19) United States
(12) Patent Application Publication
(10) Pub. No.: US 2007/0231524 A1
(43) Pub. Date: Oct. 4, 2007

(54) Security tape

(75) Inventor: Martin Wall, Chapin, SC (US)

Correspondence Address: LERNER GREENBERG STEMER LLP, P O BOX 2480, HOLLYWOOD, FL, 33022-2480, US

(73) Assignee: Matrix Groep BV

(21) Appl. No.: 11/650,805

(22) Filed: Jan. 8, 2007

Related U.S. Application Data
(63) Continuation of application No. PCT/EP05/07364, filed on Jul. 7, 2005.

(30) Foreign Application Priority Data
Jul. 8, 2004 (DE) 10 2004 033 155.3

(51) Int. Cl. B32B 33/00

(52) U.S. Cl. 428/40.1

(57) ABSTRACT

The present invention relates to a security tape (10), in particular for re-sealed banknote cartons.

The security tape (10) comprises at least one first separate zone (11) for carton sealing and at least one second separate zone (12) for tamper evidence. With such security tape (10) comprising separate zones for carton sealing (11) and tamper evidence (12a, 12b), it is possible for the first time to close and sign banknote cartons in only one packaging step. The present invention based on the idea of variable zones irrespective of the relationship between the adhesion properties of the zones ie. over a range of different adhesion scenarios. It is suitable for any packaging where carton sealing and tamper evidence is needed, in particular for re-sealed banknote cartons like for example in case of transportation of cash and banknotes for customers like Deutsche Post, Deutsche Bank, Aldi, Lidl, etc.

### BACKGROUND OF THE INVENTION

### Field of the Invention

The present invention relates to a security tape, in particular for re-sealed banknote cartons.

In the last few years technical tape products and the like have become standard safety equipment also in the business for re-sealed banknote cartons.

Such banknote cartons need solutions concerning (I) resistance to tampering, (II) one or more means of identification, (III) preferably possibilities for automation, (IV) an environmental friendliness and/or (V) a controlled availability to indicate mechanical tamper.

Until today there mostly exist adhesive tape systems for securing re-sealed banknote cartons. Such adhesive tape systems comprise at least two different tapes, one first adhesive tape which holds box flaps of a carton firmly together and one second adhesive tape, which does not hold together but instantly and clearly shows any removal, for example displaying the text “opened” or any other multi-lingual text and/or sign.

The imperative usage of at least two adhesive tapes, one first which has superior high initial adhesion and one second by which tamper evident action can not be concealed after tampering, fulfils in fact the above mentioned requirements.

Where one tape is currently used for both sealing and tamper evidence the tamper evidence, features are severely compromised in a product developed with good carton sealing characteristics or the carton sealing characteristics are severely compromised in a product developed with good tamper evidence characteristics.

Where two tapes are used a decisive disadvantage is among others, that a large time for packaging is necessary because of using two kinds of adhesive tapes.

In order to remedy this problem, automated packaging systems (for example so called standard ACS=automated case sealers) have been developed. To be able to process such packaging systems, for example comprising several tape dispensers, a kind of synchronisation is necessary. This means that the timings involved must be identically constant with regard to the packaging frequency of both adhesive tapes.

### SUMMARY OF THE INVENTION

It is accordingly an object of the invention to overcome the disadvantages of the prior art, whereby in particular it should be possible to seal banknote cartons with only one security tape without compromise in either sealing or tamper evidence performance.

With the foregoing and other objects in view there is provided, in accordance with the invention, a security tape, in particular for re-sealed banknote cartons. The security tape comprises at least one first separate zone for carton sealing and at least one second separate zone for tamper evidence. With such security tape comprising separate zones for carton sealing and tamper evidence, it is possible for the first time to close and sign banknote cartons in only one packaging step whilst providing effective tamper evidence and seal integrity.

In accordance with an added feature of the invention, the separate zone for carton sealing is arranged in the middle of the tape while on each side of that tape one separate zone for tamper evidence is arranged.

In accordance with an additional feature of the invention, a clean edge is arranged on each side of the tape. This overcomes accidental activation on high speed unwind due to any adhesive “bleed” which may have occurred and is a hazard with relatively thick adhesives on thin filmic carriers. The pigmented tamper evident zone stops before reaching either edge of the tape giving a transparent clean edge yielding the aforementioned benefit.

The central zone is in favour transparent allowing sophisticated under surface identification and coding to be viewed through the tape. It also allows for the possibility of coding which has been applied to the carton directly to be still viewed through the security tape.

To indicate edge tampering, the separate zone of the security tape for tamper evidence preferably contains special edge technology like for example serration.

In accordance with an additional feature of the invention, the tape comprises multiples layers. The number of layers allows favourably for individually tailored combinations of adhesion of the text to the tape and of adhesion to the carton.

In that context of the invention, the tape comprises preferably four layers, one for a variable release coating, one for a pigment coating, one stabilising layer, and one for an adhesive coating.

In accordance with an added feature of the invention, the layer for adhesive coating exhibits high initial adhesion force to facilitate its application.

In a preferred embodiment the layer for adhesive coating comprises variable adhesion characteristics concerning the first zone for carton sealing and the second zone for tamper evidence.

In particular the adhesive force for the first zone can be higher than the adhesive force for the second zone.

In accordance with an additional feature of the invention, the security tape material exhibits sufficient shear strength to hold box flaps of the carton together during a storage time; thus a minimum holding power of at least 10 to 14, especially 12 hours.

In accordance with an added feature of the invention, the tape contains materials which retain tamper-evidence properties even under temperatures at least in the range of −20° C. to +60° C.

Finally, and in accordance with an additional feature of the invention, the tape contains materials which are impervious to damp, so that protection and tamper-evidence properties are retained.

The present invention based on the idea of variable zones irrespective of the relationship between the adhesion properties of the zones ie. over a range of different adhesion scenarios. It is suitable for any packaging where carton sealing and tamper evidence is needed, in particular for re-sealed banknote cartons.

Other features which are considered as characteristic for the invention are set forth in the appended claims.

Although the invention is illustrated and described herein as embodied for a security tape for re-sealed banknote cartons of the European currency, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of a security tape according to the invention before any tampering;

FIG. 2 shows the security tape according FIG. 1 after some tampering;

FIG. 3 represents in section a side view of the security tape according to FIG. 1; and

FIG. 4 an extended piece “X” of FIG. 3.

### DESCRIPTION OF THE PREFERRED EMBODIMENTS

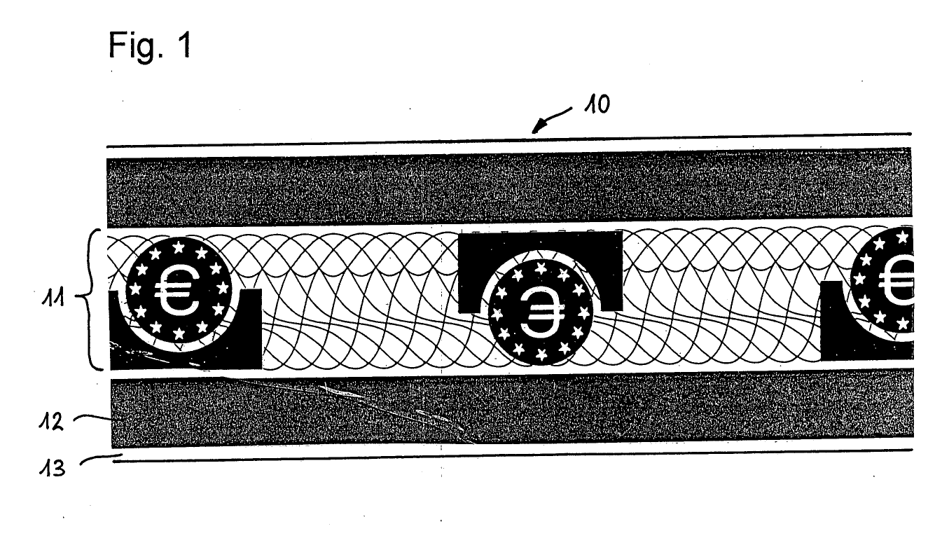

Referring now to the figures of the drawing in detail and first, particularly, to FIG. 1 thereof, there is shown a security tape 10, which, in the illustrated example, is transparent, with its main parts 12a, 12b coloured for example in Reflex Blue C.

A clean edge 13 is arranged on each side of the tape 10. This overcomes accidental activation on high speed unwind due to any adhesive “bleed” which may have occurred and is a hazard with relatively thick adhesives on thin filmic carriers. The pigmented (in this case blue) tamper evident zone 12a, 12b stops before reaching either edge of the tape giving a transparent clean edge yielding the aforementioned benefit.

Thus, we currently have from left to right—clean edge 13; tamper zone 12; transparent zone 11; tamper zone 12; clean edge 13. This pattern can be repeated in multiples of this, for example—clean edge 13; tamper zone 12; transparent zone 11; tamper zone 12; clean edge 13; tamper zone 12; transparent zone 11; tamper zone 12; clean edge 13.

Apart from the construction of the tape 10 as shown in FIG. 1 to 3 also the design or format should be protected ie. two tamper evident tracks 12 separated by a zone of adhesion 11 (or non adhesion for that matter), also two pigmented tracks 12 with clean edges 13 on their outside separated by a transparent track, also irrespective of how many times this is repeated in width.

On the under side of the tape 10 or of its roll can be printed repetitively in black signs like “ [symbol] Security tape” and/or the icon “!” (not shown), which indicate at a glance that the tape 10 should not be tampered with. The size of the “ [symbol] ” and “!” characters and of the wording can be preferentially 15 mm in height, both in Arial or comparable font.

Each security tape roll is clearly identifiable by a unique tracing number printed repetitively in black on the under side of the tape 10. That number appears at least four times on the sealed box. It should preferably not be positioned in the middle 11 of the tape 10. A two digit code may be repetitively printed on the tape 10 in addition to this number.

Such security tapes 10 are intended to be applied along the long sides of one cardboard box to seal the longer lid flaps on the top and on the bottom, so that either two stripes of tape are required per box or one stripe around the whole length of the box.

The tape reel has for example a width of 75 mm and is suitable for automated packing lines as well as hand dispensers. The usage of the tape 10 in automated packing lines preferably exhibits low noise.

Further more, the security tape 10 according to the present invention can of course be adapted in adhesion in the zones for optimum performance on different kind of cardboards.

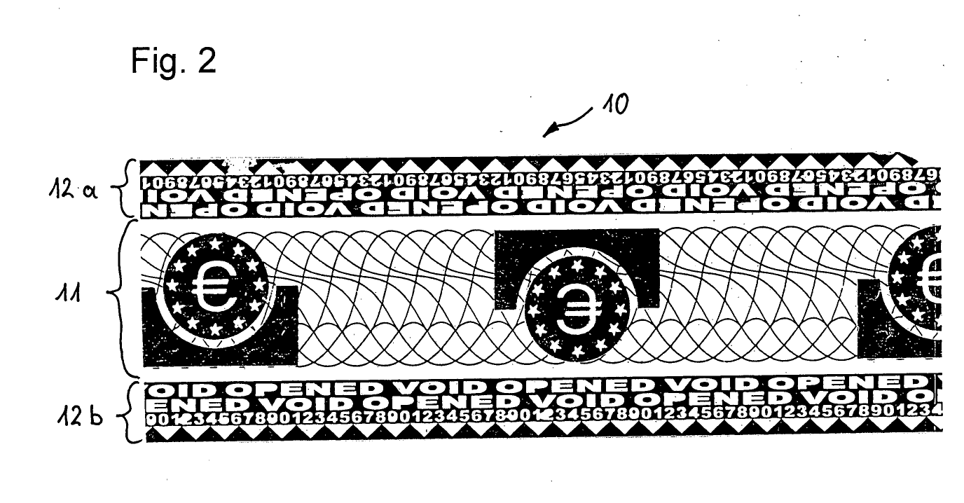

After a dwell time max. of 20 minutes after applying the tape 10, any removal of the security tape shows instantly and clearly on the cardboard by at least the words “open” or “opened”. A schematic view of the security tape 10 of the invention after such tampering is shown in FIG. 2.

As shown in FIG. 2 it is difficult to conceal any tampering by stocking the security tape 10 neatly back in place; by lining up the tape 10 once it has been cut; and by sealing the security tape 10 over with a clear tape after it has been cut; e.g. the clear tape exhibits nor or very adhesion to the security tape. This means, that the surface of the security tape 10 is constituted in a way that any clear tape can not adhere to it: an attempted manipulation will be instantly visible through a partial destruction of the security tape, mismatch in the alignment of the security graphics and a warning print on the carton.

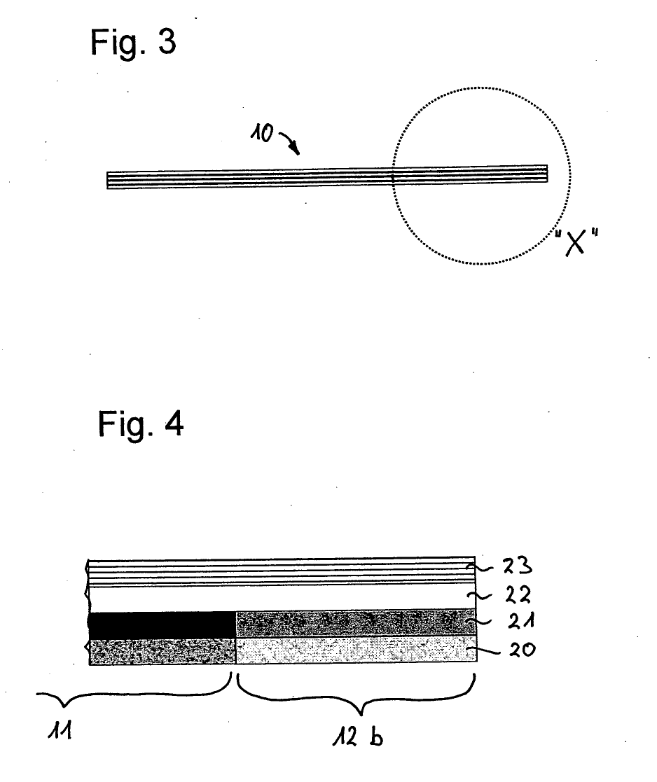

FIG. 3 represents in section a side view of the security tape 10 according FIG. 1; FIG. 4 shows an extended piece “X” of FIG. 3. As pictured therein, the tape 10 can comprise four layers, one for a variable release coating 21, one for a pigment coating 22, one stabilising layer 23, and one for an adhesive coating 20. Moreover, the layer for adhesive coating 20 comprises variable adhesion characteristics concerning the first zone 11 for carton sealing and the second zone 12a, 12b for tamper evidence. Beyond that, the adhesive force for the first zone 11 can be higher than the adhesive force for the second zone 12a, 12b.

The security tape 10 according to the present invention clearly indicates any tampering by:
mechanical tools (e.g. scalpel);
commercially available solvents;
coldness (e.g. freezing spray);
dampness; and/or
heat (e.g. hair dryer).

Especially it still exhibits tamper evidence or can be made to immediately react on tampering with heat (stream, hair dryer, etc.), coldness (ice-spray etc.) and commercially available solvents.

It self adheres to corrugated cardboard for a storage time of 5 years under normal vault conditions, thus temperature between 15 to 30° C. and/or relative humidity between 25 to 75%, while retaining its tamper-evident characteristics.

The security tape 10 further more exhibits:
sufficient shear strength to hold the box flaps together during the initial handling and transport as well as storage time, thus a minimum holding power of at least 12 hours according to the test method Pressure Sensitive Tape Council (PSTC)-7 (1 kg/25 mm×25 mm);
high initial adhesion (tack) to facilitate its application, thus less than 10 cm with test ball # 14 bal according to test method Pressure Sensitive Tape Council (PSTC)-6; and/or
Resistance to temperatures at least in the range of −20° C. to +60° C., while retaining its tamper-evident properties, during air and land transports.

These features allow a weight of 19 banknote cartons and a wooden pallet, overall some 2000 kg, to be piled upon the lowest sealed carton.

The present invention based on the idea of variable zones irrespective of the relationship between the adhesion properties of the zones ie. over a range of different adhesion scenarios. It is suitable for any packaging where carton sealing and tamper evidence is needed, in particular for re-sealed banknote cartons like for example in case of transportation of cash and banknotes for customers like Deutsche Post, Deutsche Bank, Aldi, Lidl, etc.

We claim:

1. A security tape, comprising:
a single tape defining a longitudinal direction;
said tape having at least one separate first zone for tight and mechanical carton sealing; and
said tape having at least one separate second zone for tamper evidence, said first and second zones being separate from one another and said zones being disposed running next to one another along said longitudinal direction of said tape.

2. The security tape according to claim 1, wherein said single tape is configured for resealing bank bill cartons.

3. The security tape according to claim 1, wherein said first separate zone for carton sealing is arranged centrally in a middle section of said tape, and said second zone is one of two separate second zones for tamper evidence disposed one on each said of said middle section of said tape.

4. The security tape according to claim 1, which comprises a protective seam formed on each side of the tape.

5. The security tape according to claim 1, wherein said first zone is transparent.

6. The security tape according to claim 1, wherein said at least one separate second zone for tamper evidence contains serration as a systematic edge technology to indicate edge tampering.

7. The security tape according to claim 1, wherein said tape comprises a plurality of layers.

8. The security tape according to claim 7, wherein said tape is formed of four layers, including a variable release layer, a pigment layer, a stabilizing layer, and an adhesive layer.

9. The security tape according to claim 8, wherein said adhesive layer exhibits initial adhesion force for facilitating an initial adhesion and application of said tape.

10. The security tape according to claim 8, wherein said adhesive layer is formed with variable adhesion characteristics between said first zone for carton sealing and said second zone for tamper evidence.

11. The security tape according to claim 10, wherein an adhesive force in said first zone is higher than an adhesive force in said second zone.

12. The security tape according to claim 1, wherein said tape is formed to exhibit shear strength sufficient to hold box flaps of a carton together during a given storage time.

13. The security tape according to claim 12, wherein said tape is formed with a minimum sealing power for 10 to 14 hours.

14. The security tape according to claim 12, wherein said tape is formed with a minimum sealing power for 12 hours.

15. The security tape according to claim 1, wherein said tape contains materials that retain tamper-evidence properties under temperatures in a range from −20° C. to +60° C.

16. The security tape according to claim 1, wherein said tape contains materials that are impervious to moisture, to retain protection and tamper-evidence properties.
